(19) United States
(12) Patent Application Publication
(10) Pub. No.: US 2016/0182673 A1
(43) Pub. Date: Jun. 23, 2016

(54) DYNAMIC CACHE INJECTOR

(71) Applicants: Barak Kinarti, Kfar-Yona (IL); Alex Kravchik, Petah Tikwa (IL); Daniel Turin, Caesarea (IL)

(72) Inventors: Barak Kinarti, Kfar-Yona (IL); Alex Kravchik, Petah Tikwa (IL); Daniel Turin, Caesarea (IL)

(21) Appl. No.: 14/578,792

(22) Filed: Dec. 22, 2014

(51) Int. Cl. H04L 29/08

(52) U.S. Cl. CPC H04L 67/2847

(57) ABSTRACT

A method, medium, and system to retrieve a web resource of a web site from a host server of the web site, the web resource having a validity indicator; store the web resource in a local memory of a web browser; determine whether the validity indicator is valid; and update, prior to an expiration of the validity indicator, the validity indicator of the web resource stored in the local memory of the web browser, the validity indicator including at least one of an expiration date and a build version of the web site.

### BACKGROUND

A user's experience when accessing a web site via a browser or other application or system may be negatively impacted when the time to load a particular web site is noticeable by the user. A decreased sense of satisfaction may be, from the user's perspective, associated the web site being accessed, and long loading times may be viewed as unresponsiveness. Additionally, if the user's experience includes having to wait for the accessed web site to slowly “load” each time the user navigates their web browser to the web site, this may also be viewed as poor end user experience. A need to continually fetch or download web resources associated with a web site may weaken and/or dampen a user's experience when accessing a web site by increasing the amount of time required until the web site or application are fully displayed and ready to be used.

In some contexts, there may be an expectation of near-instant availability and access to different web sites by users of a system, service, or application. Accordingly, mechanisms to efficiently facilitate an availability and access to different web sites may be desired.

### BRIEF DESCRIPTION OF THE DRAWINGS

FIG. 1 is a schematic block diagram of a system, according to some embodiments;

FIG. 2 is an illustrative flow diagram of a process, according to some embodiments;

FIG. 3 is an illustrative flow diagram of a process, according to some embodiments, in accordance with some embodiments;

FIG. 4 is an illustrative flow diagram of a process, according to some embodiments, according to some embodiments; and

FIG. 5 is a block diagram of a computing device, in accordance with some embodiments.

### DETAILED DESCRIPTION

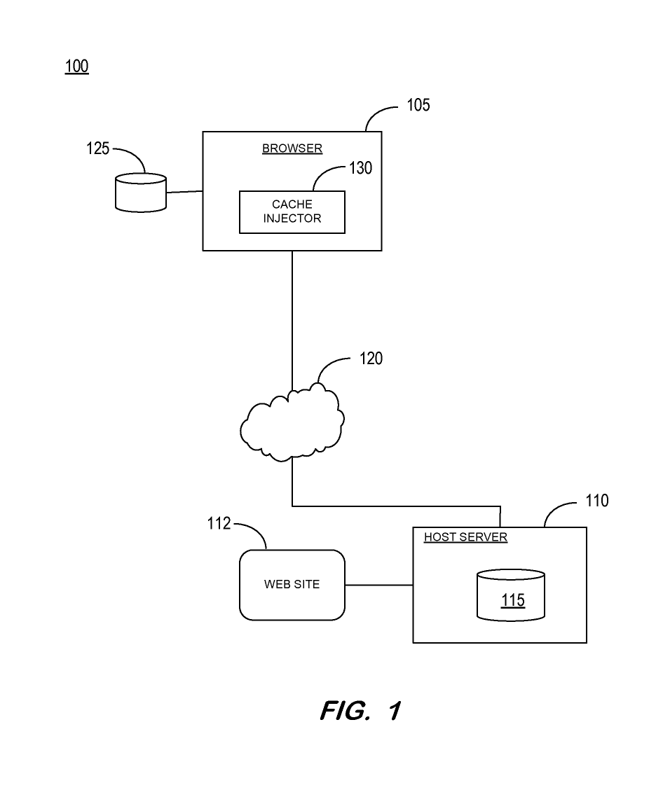

FIG. 1 is a block diagram of a system 100, according to some embodiments herein. System 100 represents a logical architecture for describing processes and a framework to provide a mechanism to automatically assure that resources required for a functionality of a web site are up to date. In some embodiments, a service or application such as, for example, web browser 105 accesses a web site 112 hosted by a server 110, via a network 120. Network 120 may be the internet or a private local area network accessible through a uniform resource locator (URL). Web hosting server or host server 110 may include a storage facility 115 for storing the web resources comprising the web site and needed by an application or service to fully realize the functions and features of web site 112. For example, web site 112 may include a plurality of webpages. The webpages of web site 112 may comprise or reference different web resources such as plain text, structured data including formatting instructions (e.g., HTML, XHTML, etc.), images, scripts, audio files, video files, multimedia files, applets, etc. These and other types of web resources comprising web site 112, and any files, data structures, and applications that may be needed by a service or application to access and to render or otherwise realize the features and functionality of web site 112, may be stored, at least temporarily, in storage 115.

In some embodiments, browser 105 may request access to web site 112 using the URL for the site. In reply to that request, the web resources of web site 112 may be returned to browser 105 by host server 110. Host server may realize, via interactions with browser 105, that browser 105 does not have the requisite web resources needed to render web site 112 (i.e., the present request is an initial access of web site 112 by browser 105). Accordingly, the requisite web resources of web site 112 may be retrieved and downloaded to browser 105. The web resources retrieved and downloaded to browser 105 may be, in some embodiments, all of the resources including files, scripts, applications, etc. necessary for browser 105 to render and fully interact with web site 112 with the functionality and features thereof. The retrieved web resources of web site 112 may be stored in a local memory associated with the browser, cache 125. In some embodiments, cache 125 may include a memory mechanism embodied on the same device or system as browser 105.

In some embodiments, each web resource has an expiration date. The expiration data may, for example, be included in a header of a file comprising the web resource. In some aspects, a web resource is good or valid for the stated period of time expressed by the expiration date thereof. For example, if a web resource has an expiration date of 1 day, then the web resource will be good or valid for 1 day after the retrieval of the web resource. At the expiration of the web resource, the particular web resource would typically have to be downloaded again (i.e., re-fetched) if the web site is to be accessed again. For example, all of the web resources of a web site 112 are downloaded to cache 125 of browser 105 from host 110 when the web site is initially accessed by the browser. Each of the multiple (e.g., dozens) downloaded web resources have an expiration date. The expiration date of the individual web resources may vary and is generally specified by a developer or other entity associated with the web site. At some subsequent time after the initial access of the web site (e.g., 8 hours later), a user of browser 105 may direct the browser to access web site 112 again. At this later visit to the web site, a number of the web resources stored in cache 125 may have expired. As such, the expired web resources can be downloaded again (i.e., re-fetched) from host server 110, while the web resources with valid expiration dates, in some embodiments, need not be re-fetched and can be had from cache 125 since all of the web resources for the rendering and functionality of the web site need to be valid (i.e., have a current, up to date expiration date).

The retrieval and downloading of web resources from a host site to a local memory 125 of a browser 105 may have an adverse impact on a user's experience when visiting web sites since the retrieval of the web resources takes time. While an initial visit to some web sites may take longer than a subsequent visit to the site made just a short time later because some and not all of the web resources downloaded in the initial visit must be re-fetched, the time needed to again download even some of the requisite web resources may be noticeable from a user's perspective.

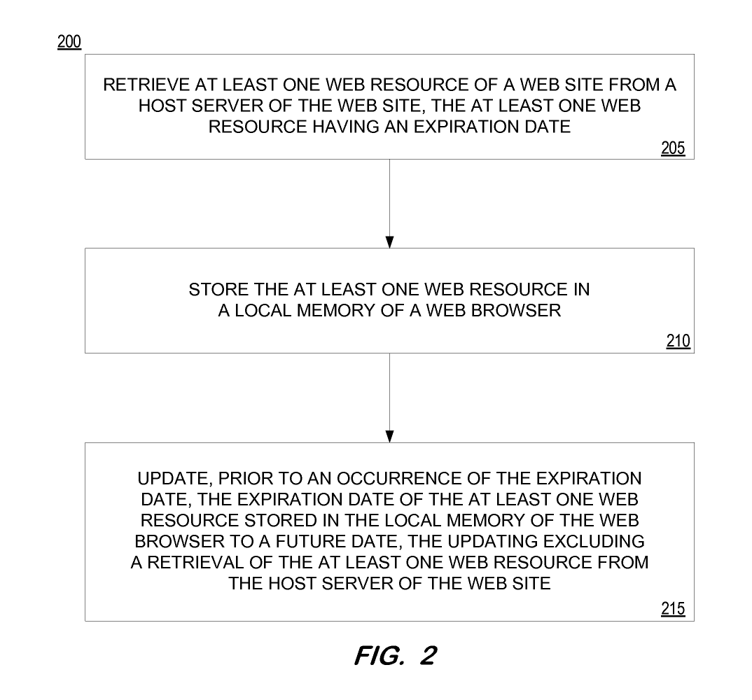

FIG. 2 is an illustrative flow diagram of a process 200, in accordance with some embodiments herein. Referring to FIG. 2, a process related to providing a mechanism to automatically maintain web resources in an up-to-date state in cache is depicted. Process 200 may be implemented by a system, application, or apparatus configured to execute the operations of the process. In some embodiments, various hardware elements of an apparatus, device or system embodying system 100 executes program instructions to perform process 200. In some embodiments, hard-wired circuitry may be used in place of, or in combination with, program instructions for implementation of processes according to some embodiments. Program instructions that can be executed by a system, device, or apparatus to implement process 200 (and other processes disclosed herein) may be stored on or otherwise embodied as non-transitory, tangible media. Embodiments are therefore not limited to any specific combination of hardware and software.

Prior to operation 205, web resources such as a web page or a web service or web application executing on a device or a server-side computing device (e.g., a host server) may be developed and deployed to one or more device(s). The web resources may be developed to enable a rendering and/or enable functionality of a web site by a client-side device or system. In some aspects, the web resources may each include an expiration date that represents a period of validity for the web resource. Web resources with valid expiration dates are needed for web site rendering and functionality. In some aspects, a web resource and a web site may have an associated identifier that indicates a version of the web resource and web site, respectively. In some embodiments, the associated validity identifier indicative of a version of the web resource and web site may be a unique identifier referred to as a version number, a build number, or the like.

At operation 205, at least one web resource of a web site is retrieved from a host server thereof. In accordance with other aspects herein, the at least one web resource may have an expiration date associated therewith. The expiration date may be included in the data comprising the retrieval of the at least one web resource. In some aspects, the expiration date may be included in a header of a file containing the retrieved web resource. However, the expiration date of a web resource herein may be formatted, configured, packaged, or communicated in other ways now known or that become known in the future. In some instances, operation 205 may be a response to an initial access of the web site by a particular browser, although this is not a limit or requirement. In some instances, the at least one web resource may include multiple web resources of different types, including for example, text documents, images, video files, music files, interactive presentations, etc.

In some embodiments, the at least one web resource may include all of the web resources needed or required to properly render the accessed web site by the browser requesting the web site and enable full functionality. In some aspects, at least some of the web resources needed may be dependent on the particular web browser or other application or service requesting access to the web site. The web resource may include any number and types of files and components, including images, documents, and other static file resources.

At operation 210, the at least one web resource retrieved at operation 205 is stored in a local memory of the browser. The local memory may be a cache storage facility of the web browser. The local memory of the browser is not limited to a particular type of memory device or system herein.

Operation 215 includes updating the expiration date of the at least one web resource stored in the local memory of the web browser, prior to an occurrence of the at least one web resource's expiration date. The updating of the web resource's expiration date does not include or involve a re-fetching of the at least one web resource from the host server. In some embodiments where the browser is operating on a client device or system, operation 215 occurs on the client-side without any communication to the host server of the at least one web resource. In this manner, the updating of operation 215 may be said to exclude a retrieval of the at least one web resource from the host server of the web site.

In some embodiments, the updating of the expiration date of the at least one web resource to a future date prior to an occurrence of the expiration date may further include or be based on a determination that the at least one web resource is still valid since being retrieved at operation 205. In some embodiments, the future date of the updated expiration date is determined specifically for each of the at least one web resources. In some instances, the future date may be updated to extend a period of validity similar to the original expiration date, although this is not a requirement.

In some instances where it is determined that the at least one web resource is no longer or otherwise valid since being retrieved (e.g., the web resource as currently required by the web site has been altered in some way), the web resource may not have its expiration dated updated without the retrieval of the web resource from the host server. In some such instances, the web resource may be retrieved from the host server to obtain a current, valid version of the web resource. The determination of whether the at least one web resource is still valid and the retrieval of a valid version of the web resource if it has been altered or is otherwise not valid may be performed prior to an occurrence of the expiration date of the at least one web resource. In this manner, the at least one web resource may be maintained in an up-to-date status, before the at least one web resource ever expires.

In some aspects, process 200 may be performed automatically by a device, system, application, or service implementing the operations thereof. In some embodiments, aspects of process 200 may be implemented in a web browser via, for example, a plug-in, an extension, an applet, a script, a revision of the browser's coding to incorporate the functions of process, and other techniques. In some embodiments, process 200 may operate in the background within a browser.

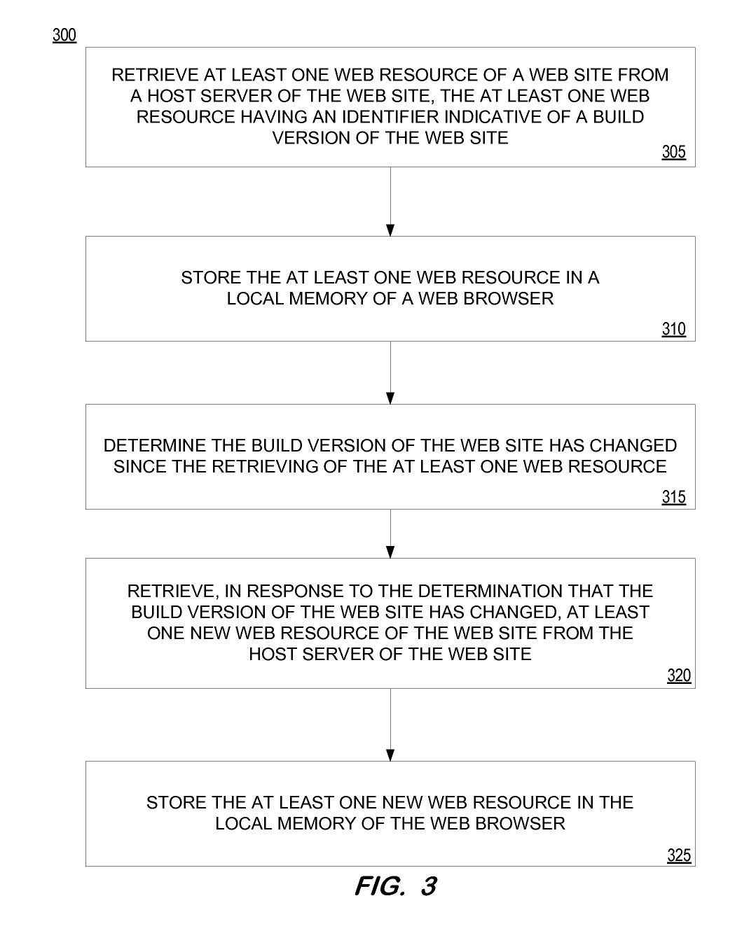

FIG. 3 is an illustrative example of a process related to providing a mechanism to automatically maintain web resources in cache in an up-to-date state. Process 300 may be implemented by a system, application, or apparatus configured to execute the operations thereof. In some embodiments, like other processes disclosed herein, various hardware elements of an apparatus, device or system embodying system 100 execute program instructions to perform process 300. Also, in some embodiments hard-wired circuitry may be used in place of, or in combination with, program instructions for implementation of processes according to some embodiments.

Prior to operation 305, web resources such as a web page or a web service or web application executing on a device or a server-side computing device (e.g., a host server) may be developed and deployed to one or more device(s). In some aspects, the web resources may each include a build version. In some aspects, the build version may be represented by a unique identifier. In some aspects, the build version may be unique for each build or version of the web site. For example, the build version of the web site and its associated web resources may be changed in response to an addition, deletion, and alteration/revision of the features, content, and functionality of the web site. An example of changes may include the addition, deletion, and revision of images, documents, and user interface elements comprising a web site. In some aspects, the build version may represent a validity identifier for the web site and its resources.

At operation 305, at least one web resource of a web site is retrieved from a host server thereof. In accordance with some aspects herein, the at least one web resource may have a build version associated therewith. The build version may be included in the data comprising the retrieval of the at least one web resource. In some aspects, the build version may be included in a header or other portion of a file containing the retrieved web resource. However, the build version of a web resource herein may be formatted, configured, packaged, or communicated in a message and other ways now known or that become known in the future. In some instances, operation 305 may be a response to an initial access of the web site by a particular browser, although this is not a limit or requirement. In some instances, the at least one web resource may include multiple web resources of different types, including for example, text documents, images, video files, music files, interactive presentations, etc.

In some embodiments, the at least one web resource may include all of the web resources needed or required for the proper rendering and functionality of the accessed web site by the browser requesting the web site.

Operation 310 may include storing the at least one web resource retrieved at operation 305 in a local memory of the browser, referred to as a cache storage facility of the web browser. However, the local memory of the browser is not limited to a particular type of memory device or system herein.

Operation 315 may include determining whether the build version of the at least one web resource has changed since it was retrieved at operation 305. A change in the build version of the web site and its web resources may be indicative of revisions to the web site and/or the web resources thereof.

Proceeding to operation 320, at least one new web resource of the web site may be retrieved from the host server of the web site in response to a determination at operation 315 that the build version of the web site has changed. In the instance the build version has changed, an updated version of the at least one web resource is requested by the browser from the host server (i.e., pulled) or provided unsolicited from the host server to the browser (i.e., pushed), depending on the configurations and communications between the web browser and the host server.

In some embodiments, a plug-in, service, or extension (e.g., FIG. 1, cache injector 130) implementing aspects of process 300 may be notified of the change or alteration of a web site and the web resources of a web site 112 by the host server 110 of the web site. In a context where the consuming web browser has no control or jurisdiction of the server side of, for example, system 100, the client-side browser 105 may query the host server 110 regarding whether the web resources it has previously downloaded and stored in its cache 125 for the web site are still relevant and/or up-to-date (i.e., no version changes). The browser 105 may continually contact the host server 110 regarding whether its stored web resources are relevant and up-to-date at regular or varying intervals. In some embodiments, the intervals may be predetermined or periodically calculated and in some instances the intervals may be so short as to make the querying appear to be continuous (i.e., normally, without interruption). In this scenario, notifications of changes to a web resource and/or a web site may be “pulled” by web browser from the host server 105. The notifications may include a build-time stamp for the web resources and the web site.

In some embodiments, an application or host server 110 of a web site 112 having associated web resources may be configured to provide (i.e., “push”) notifications of a change or alteration of the web site and web resources thereof to a browser that accesses the web site. In a context where the consuming web browser 105 or other entity may have some control or jurisdiction of the application or host server side of, for example, system 100, then host server 110 or an application need not be queried by the browser server regarding whether the web resources of the hosted web site are still relevant and/or up-to-date (i.e., no version changes). In this scenario, the application or host server 110 may provide notifications of web site and web resource changes to the browser 105 unsolicited.

In some embodiments, in an instance where a web resource is not subject to any changes since an initial or last download and storage in a web browser's cache, the web browser need not contact the host server to retrieve or re-fetch an updated version of the web resource. In these instances, the browser may maintain an updated version of the web resource by updating, on the client-side, the expiration date without contacting the host server. The logic for implementing and updating of the web resource(s) expiration date may be viewed as being server agnostic or universal in some embodiments.

In some embodiments, the host server may send notifications to the browser only when web resources are changed. The notifications may include a build-time stamp for the web resources and the web site.

Referring again to process 300, the at least one new web retrieved at operation 320 may be stored in the local memory or cache of the web browser. Storing the at least one new web in the cache of the web browser may provide a mechanism for keeping the locally stored web resources in an up-to-date state so that recurrent access of web sites by a browser may be performed without possible performance decreases associated with the re-fetching and downloading of web resources.

In some embodiments, at least a portion of process 300 may be performed automatically by a system or device, without user intervention.

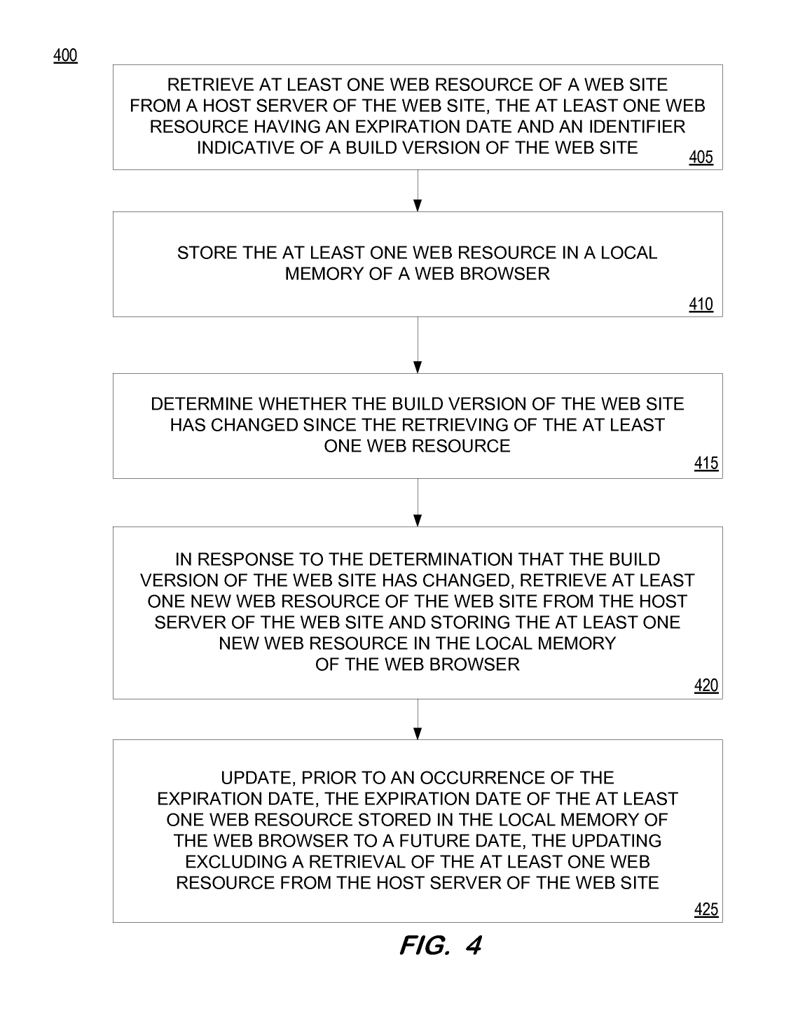

In some embodiments, a system or device may implement embodiments including some aspects of both processes 200 and 300. Process 400 of FIG. 4 is such an embodiment. That is, process 400 includes a combination of some aspects of FIG. 2 and some aspects of FIG. 3, including considerations of a validity indicator of a web resource, whether the validity indicator is an expiration date and/or a build version.

Operation 405 includes retrieving at least one web resource of a web site 112 from a host server 110 of the web site. In some aspects, the at least one web resource has a validity indicator associated therewith. In particular embodiments, the validity indicator may include one or more of an expiration date and an identifier indicative of a build version of the web site 112 or the web resource itself.

Operation 410 includes storing the at least one web resource retrieved at operation 405 in a local memory of a web browser. In some regards, the local memory may be used for caching the at least one web resource so that it may be readily and quickly recalled when its associated browser wants to subsequently access the web site.

Process 400 may proceed to operation 415 where a determination may be made regarding whether the build version of the web site has changed since the retrieving thereof at operation 405. The retrieval of the at least one web resource at operation 405 may constitute an initial or at least a last retrieval of the at least one web resource.

At operation 420, at least one new web resource of the web site may be retrieved from the host server of the web site in response to the determination at operation 415 that the build version of the web site has changed. Additionally, operation 420 (or another operation) may store the at least one new web resource in the local cache of the web browser. In this manner, the version of the at least one web resource stored in the local memory of the web browser can be automatically updated.

Operation 425 includes updating an expiration date of the at least one web resource stored in the local memory or cache of the web browser to a future date, prior to an occurrence of the expiration date. The updating may be performed to the exclusion of or without a retrieval of the at least one web resource from the host server of the web site. That is, the expiration date may be updated by the browser (or a service thereof) without obtaining, downloading, or (re-)fetching the web resource from the host server of the web site.

In some embodiments, process 400 may be modified in accordance with other aspects herein, including but not limited to the specific disclosures related to processes 200 and 300.

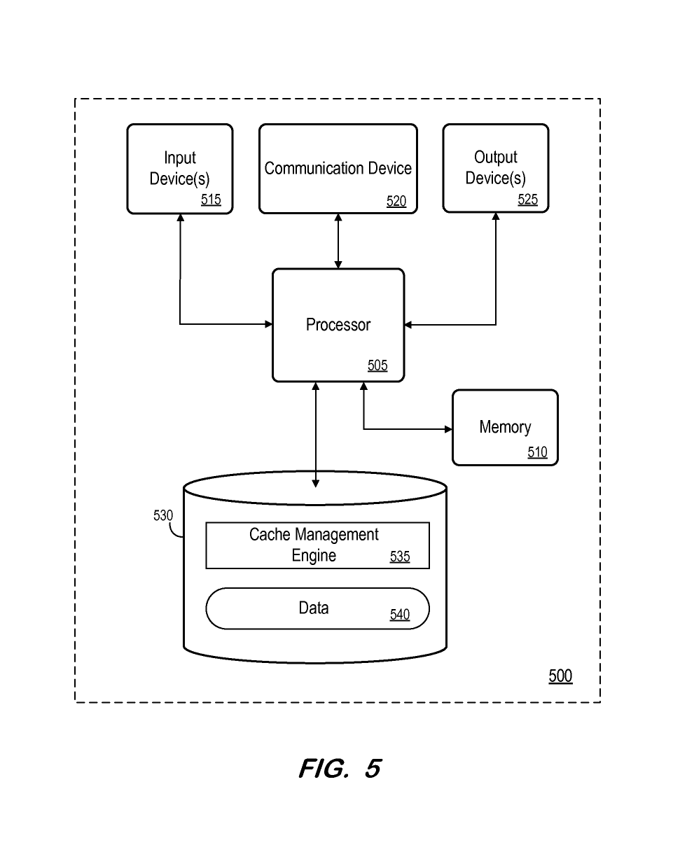

FIG. 5 is a block diagram overview of a system or apparatus 500 according to some embodiments. System 500 may be, for example, associated with devices for implementing a platform and or processes disclosed herein. System 500 comprises a processor 505, such as one or more commercially available Central Processing Units (CPUs) in the form of one-chip microprocessors or a multi-core processor, coupled to a communication device 520 configured to communicate via a communication network (not shown in FIG. 5) to another device or system (e.g., a different web page or web service server). In the instance system 500 comprises a device or system, communication device 520 may provide a mechanism for system 500 to interface with a monitored entity (e.g., an application, device, system, or service). System 500 may also include a cache 510, such as RAM memory modules. The system may further include an input device 515 (e.g., a touchscreen, mouse and/or keyboard to enter content) and an output device 525 (e.g., a touchscreen, a computer monitor to display, a LCD display).

Processor 505 communicates with a storage device 530. Storage device 530 may comprise any appropriate information storage device, including combinations of magnetic storage devices (e.g., a hard disk drive), optical storage devices, solid state drives, and/or semiconductor memory devices. In some embodiments, storage device 530 may comprise a cache management engine, including in some configurations an in-memory database.

Storage device 530 may store program code or instructions 535 that may provide processor executable instructions for managing a cache of a browser to automatically maintain web resources stored therein in an up-to-date state, in accordance with processes herein. Processor 505 may perform the instructions of the program instructions for cache management engine 535 to thereby operate in accordance with any of the embodiments described herein. Program instructions 535 may be stored in a compressed, uncompiled and/or encrypted format. Program instructions for cache management engine 535 may furthermore include other program elements, such as an operating system, a database management system, and/or device drivers used by the processor 505 to interface with, for example, a monitored entity and peripheral devices (not shown in FIG. 5). Storage device 530 may also include data 540. Data 540 may be used by system 500, in some aspects, in performing one or more of the processes herein, including individual processes, individual operations of those processes, and combinations of the individual processes and the individual process operations.

All systems and processes discussed herein may be embodied in program code stored on one or more tangible, non-transitory computer-readable media. Such media may include, for example, a floppy disk, a CD-ROM, a DVD-ROM, a Flash drive, magnetic tape, and solid state Random Access Memory (RAM) or Read Only Memory (ROM) storage units. Embodiments are therefore not limited to any specific combination of hardware and software.

In some embodiments, aspects herein may be implemented by an application, device, or system to manage recovery of an entity or other application in a consistent manner across different devices, effectively across an entire domain.

Although embodiments have been described with respect to cloud-based entities, some embodiments may be associated with other types of entities that need not be cloud-based, either in part or whole, without any loss of generality.

The embodiments described herein are solely for the purpose of illustration. Those in the art will recognize other embodiments which may be practiced with modifications and alterations.

What is claimed is:

1. A method implemented by a computing system in response to execution of program instructions by a processor of the computing system, the method comprising:
retrieving at least one web resource of a web site from a host server of the web site, the at least one web resource having an expiration date;
storing the at least one web resource in a local memory of a web browser;
updating, prior to an occurrence of the expiration date, the expiration date of the at least one web resource stored in the local memory of the web browser to a future date, the updating excluding a retrieval of the at least one web resource from the host server of the web site.

2. The method of claim 1, further comprising:
determining, prior to an occurrence of the expiration date, the at least one web resource has been altered since being retrieved; and
retrieving, in response to the determination that the at least one web resource has been altered, an updated version of the at least one web resource from the host server of the web site.

3. The method of claim 1, wherein the updating of the expiration date of the at least one web resource to a future date prior to an occurrence of the expiration date further comprises determining the at least one web resource is still valid since being retrieved.

4. The method of claim 1, wherein the at least one web resource comprises all requisite resources for rendering the web site and enabling functionality in accordance with an initial access of the web site.

5. The method of claim 1, wherein the future date of the updated expiration date is determined specifically for each of the at least one web resources.

6. The method of claim 1, wherein the at least one web resource comprises, at least in part, static resources for the web site's rendering and functionality.

7. A method implemented by a computing system in response to execution of program instructions by a processor of the computing system, the method comprising:
retrieving at least one web resource of a web site from a host server of the web site, the at least one web resource having an identifier indicative of a build version of the web site;
storing the at least one web resource in a local memory of a web browser;
determining the build version of the web site has changed since the retrieving of the at least one web resource;
retrieving, in response to the determination that the build version of the web site has changed, at least one new web resource of the web site from the host server of the web site; and
storing the at least one new web resource in the local memory of the web browser.

8. The method of claim 7, wherein the at least one web resource comprises all requisite resources for rendering and functionality of the web site in accordance with an initial access of the web site.

9. The method of claim 7, further comprising:
querying the host server of the web site whether the build version of the web site has changed since the retrieving of the at least one web resource; and
receiving, in response to the querying, a notification that the build version of the web site has changed since the retrieving of the at least one web resource.

10. The method of claim 7, further comprising:
configuring the host server of the web site to generate a notification when a build version of the web site changes; and
receiving, from the host server of the web site, a notification that the build version of the web site has changed.

11. The method of claim 7, wherein the at least one new web resource of the web site is automatically retrieved from the host server of the web site.

12. The method of claim 7, wherein the at least one new web resource corresponds to at least one of a new feature, a new function, an updated feature, and an updated function of the web site.

13. A method implemented by a computing system in response to execution of program instructions by a processor of the computing system, the method comprising:
retrieving at least one web resource of a web site from a host server of the web site, the at least one web resource having an expiration date and an identifier indicative of a build version of the web site;
storing the at least one web resource in a local memory of a web browser;
determining whether the build version of the web site has changed since the retrieving of the at least one web resource;
in response to the determination that the build version of the web site has changed, retrieving at least one new web resource of the web site from the host server of the web site and storing the at least one new web resource in the local memory of the web browser; and
updating, prior to an occurrence of the expiration date, the expiration date of the at least one web resource stored in the local memory of the web browser to a future date, the updating excluding a retrieval of the at least one web resource from the host server of the web site.

14. The method of claim 13, wherein the at least one web resource comprises all requisite resources for rendering the web site and enabling functionality in accordance with an initial access of the web site.

15. The method of claim 13, wherein the future date of the updated expiration date is determined specifically for each of the at least one web resources.

16. The method of claim 13, wherein the at least one web resource comprises, at least in part, static resources for enabling rendering and functionality of the web site.

17. The method of claim 13, further comprising:
querying the host server of the web site whether the build version of the web site has changed since the retrieving of the at least one web resource; and
receiving, in response to the querying, a notification that the build version of the web site has changed since the retrieving of the at least one web resource.

18. The method of claim 13, further comprising:
configuring the host server of the web site to generate a notification when a build version of the web site changes; and
receiving, from the host server of the web site, a notification that the build version of the web site has changed.

19. The method of claim 13, wherein the at least one new web resource of the web site is automatically retrieved from the host server of the web site.

20. The method of claim 13, wherein the at least one new web resource corresponds to at least one of a new feature, a new function, an updated feature, and an updated function of the web site.
